(19) United States
(12) Patent Application Publication
(10) Pub. No.: US 2025/0068738 A1
(43) Pub. Date: Feb. 27, 2025

(54) APPARATUS FOR GENERATING AN ATTESTATION MEASUREMENT, AN APPARATUS FOR VERIFYING AN ATTESTATION MEASUREMENT AND A METHOD

(71) Applicants: Ned M. SMITH, Beaverton, OR (US); Bin XING, Hillsboro, OR (US); Vincent R. SCARLATA, Beaverton, OR (US)

(72) Inventors: Ned M. SMITH, Beaverton, OR (US); Bin XING, Hillsboro, OR (US); Vincent R. SCARLATA, Beaverton, OR (US)

(21) Appl. No.: 18/895,512

(22) Filed: Sep. 25, 2024

(51) Int. Cl. G06F 21/57; G06F 21/55; G06F 21/64

(52) U.S. Cl. CPC G06F 21/57; G06F 21/552; G06F 21/64

(57) ABSTRACT

It is provided an apparatus comprising interface circuitry, machine-readable instructions, and processing circuitry to execute the machine-readable instructions. The machine-readable instructions include instructions to generate a first attestation measurement of a runtime image executed in a confidential computing environment at a first point in time. The machine-readable instructions further include instructions to store the first attestation measurement as baseline attestation measurement in a storage circuitry. The machine-readable instructions further include instructions to generate a second attestation measurement of the runtime image executed in confidential computing environment at a second point in time. The machine-readable instructions further include instructions to generate an attestation evidence report based on the baseline attestation measurement and the second attestation measurement.

### BACKGROUND

Confidential Computing Environments (CCE) are designed to safeguard sensitive data and operations by ensuring that all computations occur within a secure and isolated environment. A challenge in this field may be to maintain the integrity and security of various components within the CCE, such as workloads and other critical system elements. Ensuring that these components remain untampered with and uncompromised over time is important for upholding the overall security of the CCE. For instance, measurements of these components, combined with verification methods, may be used to detect and address unauthorized changes or potential threats. It may be desirable to improve these measurements.

### BRIEF DESCRIPTION OF THE FIGURES

Some examples of apparatuses and/or methods will be described in the following by way of example only, and with reference to the accompanying figures, in which

FIG. 1 illustrates a block diagram of an example of an apparatus for generating an attestation measurement;

FIG. 2 illustrates a flowchart of an example of a method;

The FIG. 3 illustrates a block diagram of an example of an apparatus for verifying an attestation measurement;

FIG. 4 illustrates a flowchart of an example of a method;

FIG. 5 illustrates a system;

FIG. 6 illustrates an example of an architecture of a CCE; and

FIG. 7 illustrates an example of a flow chart of a dynamic measurement process of a CCE.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

In previous approaches an attestation measurement of a CCE or part of a CCE may be collected when a component of the CCE (such as software and/or firmware) is loaded or installed. Hardware components of the CCE may contain embedded firmware that is loaded when the component is integrated with another component such as a system on chip, motherboard, chip-let, etc. A load time collection of attestation measurements may be considered as a static representation of the CCE. The configuration of the CCE may not change unless the CCE or its host system is reset, and the same or different ingredients are loaded. Attestation of such a system reports its static integrity profile. However, advanced update features such has hot patching, dynamic software update, and hot plug may invalidate these static attestation measurement and integrity profiles. Attestation verifiers and relying parties may in these cases required to guess whether the existence of a more recent software update or configuration change has been applied to CCE after the static attestation evidence report has been evaluated.

The disclosed technique describes a dynamic attestation technique and overcomes inefficiencies of previous attestation workflows. For example, a supplier of a component or image of the CCE may produce a reference integrity manifest (RIM) that contains reference measurement values for the specific component of the CCE. These RIMS are compared to actual measured attestation measurements to determine if there is a difference. In case of a dynamic attestation workflow, it may be difficult for a supplier to know what reference values to put in a RIM. This is because a dynamic measurement operation may collect a measurement over the in-memory representation of the workload (which may include multiple dynamically loaded and linked images) represented as a single image. Therefore, a CEE measurement collection capability (e.g., Intel® TDX/SGX) is descried to read the CEE memory region after it has been loaded and linked. The memory region may contain both code and data. For example, data may be omitted from attestation measurements due to its sensitive nature. To facilitate code-only measurement, code and data pages may be kept separately in memory. Only the code pages may be read by during measurement collection. A first time a dynamic attestation measurement is collected it may be regarded as the baseline attestation measurement. The baseline measurement may be used to compare subsequent dynamic attestation measurements. If the subsequent attestation measurements differ from the baseline attestation measurement, that signifies a possible malicious change to the currently running CEE. This approach may be described as a tripwire, where the baseline lays the tripwire, and subsequent measurements that differ are the equivalent of tripping the tripwire. To avoid false positives, for example scheduled changes and alterations to the CCE and/or the runtime image (such as application of a patch or component replacement) may result in the generation of a new baseline attestation measurement. For example, a history of baseline attestation measurement changes may be audited and inspected to ensure they correlate with scheduled events. This tripwire functionality may be integrated into CCEs such as Intel® TDX or the like.

For example, the proposed technique may be used in the context of a verifier such as by Intel® Tiber/Trust Authority or similar services to monitor and detect unscheduled or malicious changes and alterations to operating CCE workloads. Long running workloads may be less likely to be integrity checked (via attestation) because first a reset of the workload may trigger re-attestation. However, with long running workloads, the time between periodic integrity checks may be significantly longer than the period which as configured as periodic integrity checks for the system. This approach allows periodic system integrity checking policies to be consistent regardless of whether the workload is short or long running. Therefore, security risks may be better predicted for a data center.

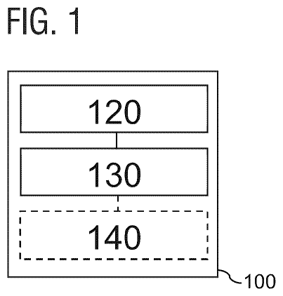

FIG. 1 illustrates a block diagram of an example of an apparatus for generating an attestation measurement 100 or device for generating an attestation measurement 100. The apparatus for generating an attestation measurement 100 comprises circuitry that is configured to provide the functionality of the apparatus 100. For example, the apparatus 100 of FIG. 1 comprises interface circuitry 120, processing circuitry 130 and (optional) storage circuitry 140. For example, the processing circuitry 130 may be coupled with the interface circuitry 120 and optionally with the storage circuitry 140.

For example, the processing circuitry 130 may be configured to provide the functionality of the apparatus 100, in conjunction with the interface circuitry 120. For example, the interface circuitry 120 is configured to exchange information, e.g., with other components inside or outside the apparatus 100 and the storage circuitry 140. Likewise, the device 100 may comprise means that is/are configured to provide the functionality of the device 100.

The components of the device 100 are defined as component means, which may correspond to, or implemented by, the respective structural components of the apparatus 100. For example, the device 100 of FIG. 1 comprises means for processing 130, which may correspond to or be implemented by the processing circuitry 130, means for communicating 120, which may correspond to or be implemented by the interface circuitry 120, and (optional) means for storing information 140, which may correspond to or be implemented by the storage circuitry 140. In the following, the functionality of the device 100 is illustrated with respect to the apparatus 100. Features described in connection with the apparatus 100 may thus likewise be applied to the corresponding device 100.

In general, the functionality of the processing circuitry 130 or means for processing 130 may be implemented by the processing circuitry 130 or means for processing 130 executing machine-readable instructions. Accordingly, any feature ascribed to the processing circuitry 130 or means for processing 130 may be defined by one or more instructions of a plurality of machine-readable instructions. The apparatus 100 or device 100 may comprise the machine-readable instructions, e.g., within the storage circuitry 140 or means for storing information 140.

The interface circuitry 120 or means for communicating 120 may correspond to one or more inputs and/or outputs for receiving and/or transmitting information, which may be in digital (bit) values according to a specified code, within a module, between modules or between modules of different entities. For example, the interface circuitry 120 or means for communicating 120 may comprise circuitry configured to receive and/or transmit information.

For example, the processing circuitry 130 or means for processing 130 may be implemented using one or more processing units, one or more processing devices, any means for processing, such as a processor, a computer or a programmable hardware component being operable with accordingly adapted software. In other words, the described function of the processing circuitry 130 or means for processing 130 may as well be implemented in software, which is then executed on one or more programmable hardware components. Such hardware components may comprise a general-purpose processor, a Digital Signal Processor (DSP), a micro-controller, etc.

For example, the storage circuitry 140 or means for storing information 140 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

The processing circuitry 130 is configured to generate a first attestation measurement of a runtime image executed in a confidential computing environment (CCE) at a first point in time. The processing circuitry 130 is further configured to store the first attestation measurement as baseline attestation measurement in a storage circuitry. The processing circuitry 130 is further configured to generate a second attestation measurement of the runtime image executed in the confidential computing environment at a second point in time. The processing circuitry 130 is further configured to generate an attestation evidence report based on the baseline attestation measurement and the second attestation measurement.

A measurement of the CCE or a part of the CCE may represent the state of a component, such as a hardware, software or firmware component involved with the CCE at a specific point in time. A measurement may be a digest, such as a cryptographic hash, that uniquely reflects the state of the CCE and/or one or more of its components at that specific point in time. For example, the measurement of the runtime image may include a cryptographic hash of the runtime image's in-memory representation. For example, the measurement of the runtime image may capture the state of the workload, libraries, runtime environment, and bring-up code. For example, the measurement of the runtime image may be a measurement of the pre-load image or the post-load image. Thereby, the operational state at a point in time of the measurement of the measured components being executed within the CCE is accurately reflected. In some examples, the measurement of the CCE may comprise a measurement of the execution environment of the CCE. This may comprise a cryptographic hash of the runtime image in conjunction with the environment's state. In some examples, the measurement of the execution environment of the CCE is similar to the measurement of the runtime image.

In some examples, the measurement may be a static measurement, which is a measurement of the system's components taken during or after the initial loading of the CCE. A static measurement captures the state of CCE and its components in a trusted, unchanging condition. These static measurements may be compared to an untampered reference measurement of the CCE and its components, that are for example established by the hardware/software of the CCE and its components, to verify the integrity.

In some examples, the updates or patches of one or more components of the CCE and/or the runtime image may be performed. These components may be dynamically updated or patched while the system is running, leading to changes in the in-memory representation (runtime image). Measuring these dynamically updated components of the CCE is referred to as a dynamic measurement. These dynamic measurements may be compared to reference measurements, which are referred to as baseline attestation measurements, to verify the integrity. The baseline attestation measurements may be obtained after an update or the like has taken place to reflect the updated, trusted state of these components, ensuring that the integrity of the system remains intact even after modifications.

The first attestation measurement is regarded as a baseline attestation measurement. The baseline attestation measurement may be stored and serves as a reference measurement to compare with subsequent measurements in the attestation process. In the attestation process, a verifier may verify if the CCE or parts of the CCE, such as the runtime image, have been tampered with or corrupted between the point in time the baseline attestation measurement is obtained and the point in time subsequent measurement is obtained. In other words, the baseline attestation measurement is used for subsequent audit and compliance inspections. The verifier may receive the baseline attestation measurement and the subsequent measurement and compare them. If the subsequent measurement matches the baseline attestation measurement, the verifier can confirm that the runtime image is operating as expected and has not been tampered between the point in time the baseline attestation measurement is obtained and the point in time subsequent measurement is obtained. In other words, if subsequent measurements differ from the baseline attestation measurement, it may indicate potential unauthorized changes or security breaches in the runtime image. The baseline attestation measurement in this regards may act as a tripwire for detecting anomalies. In some examples, the baseline attestation measurement of the runtime image is taken directly after the runtime image is initially loaded and executed within the CCE. However, whenever legitimate changes to the runtime image occur, such as a patch, hot patching, software-update, or other authorized alterations the baseline attestation measurement may be updated. Therefore, by updating the baseline attestation measurement after these legitimate changes, the system maintains an accurate and trusted reference measurement of its current state, ensuring that the baseline attestation measurement always represents the most recent secure state of the runtime image.

In some examples, the processing circuitry 130 is further configured to transmit the attestation evidence report to a verifier. For example, the attestation evidence report may be used to verify the integrity and security of the CCE and/or a part of the CCE, such as the runtime image. The attestation evidence report may be used in an attestation process to provide verifiable proof to a verifier that the CCE and/or a part of the CCE at the second point in time are secure, untampered with, and operating as expected, allowing the verifier to establish trust in the CCE's integrity and security status. In some examples, the attestation evidence report comprises both the baseline attestation measurement and the second measurement. In some examples, the verifier is configured to compare the baseline attestation measurement and the second attestation measurement. In some examples, the attestation evidence report may further comprise the names of modules loaded into the runtime image and/or the CCE. In some examples, the attestation evidence report may comprise the static attestation measurements which may be compared to a manufacture issued reference measurement (also referred to as reference integrity manifest (RIM)).

In some examples, the processing circuitry 130 is further configured to compare the baseline attestation measurement and the second attestation measurement. For example, the two hashes or digests may be compared. If baseline attestation measurement and the second attestation measurement match for example a positive attestation result may be generated. For example, the positive attestation result may be data that comprises information that the baseline attestation measurement and the second attestation measurement are equal and that therefore the integrity of the workload at the second point in time may be verified. For example, if the baseline attestation measurement and the second attestation measurement do not match a negative attestation result may be generated. For example, the negative attestation result may be data that comprises information that the baseline attestation measurement and the second attestation measurement are not equal and that therefore the integrity of the workload at the second point in time may not be verified. The attestation result may be included into the attestation report. In another examples, the comparing of the baseline attestation measurement and the second attestation measurement and the corresponding assessment of integrity may be done by the verifier. The attestation result may be delivered to a relying party, which wants to know of the CCE and/or the runtime image, for example the application, which is part of the runtime image, is un-tampered and secure.

The baseline attestation measurement and/or the second measurement may be stored in the storage circuitry 140. For example, the storage circuitry 140 may be an integrity register. That is, for example, the baseline attestation measurement and the second measurement may be separate values that both may be stored in the secure storage circuitry 140. An integrity register may be a specialized form of non-volatile memory used to securely store cryptographic measurements, such as hashes. Integrity registers may be specifically designed to hold integrity data securely and persistently. These registers may be protected against unauthorized access and modification, ensuring that the stored measurements remain unchanged. This allows the system to use these integrity registers as a trusted reference point for verifying its integrity over time, even across reboot. For example, the integrity register is a runtime measurement integrity register of a trusted domain CCE (referred to as RTTD).

A CCE architecture may comprise a combination of specialized hardware and software components designed to protect data and computations from unauthorized access and tampering within a computer system. The CCE architecture may provide secure processing circuitry, which is responsible for executing sensitive workloads in an isolated environment. Additionally, the CCE architecture may provide secure memory, such as a protected region of the computer system's RAM, where sensitive data can be stored during computation. To further safeguard this data, the CCE architecture may provide memory encryption, ensuring that the contents of the system memory are protected even if physical access to the memory is obtained. For example, the CCE architecture may support I/O isolation and secure input/output operations, preventing data leakage during communication between the processing circuitry and peripheral devices. In some examples, the CCE architecture may provide secure storage capabilities of the computer system, such as a secure partition within the system's main storage, dedicated to storing cryptographic keys, sensitive configuration data. This secure storage ensures that critical data remains protected even when at rest. In some examples, the CCE may also comprise separate secure storage components, such as a tamper-resistant storage chip, like an integrity measurement register, to securely store measurements of the CCE and/or critical data associated with the CCE's operation. A host may generate one or more instances of CCEs based on the CCE architecture. The instances of the CCE architecture may be referred to as a CCE (also referred to as a Trusted Execution Environment). The CCE uses its components to enable the secure and isolated execution of workloads. A workload executed in the CCE may include a set of applications, tasks, or processes that are actively managed and protected by these secure hardware components. This includes computational activities that utilize the CCE's resources, including CPU, memory, and storage, to perform their operations. Such activities may involve running applications, processing sensitive data, performing calculations, and managing tasks that require a high level of security and confidentiality. The CCE ensures that these workloads are protected from unauthorized access and tampering by leveraging hardware-based security features and cryptographic measures, thereby maintaining the integrity and confidentiality of the data and processes throughout their execution

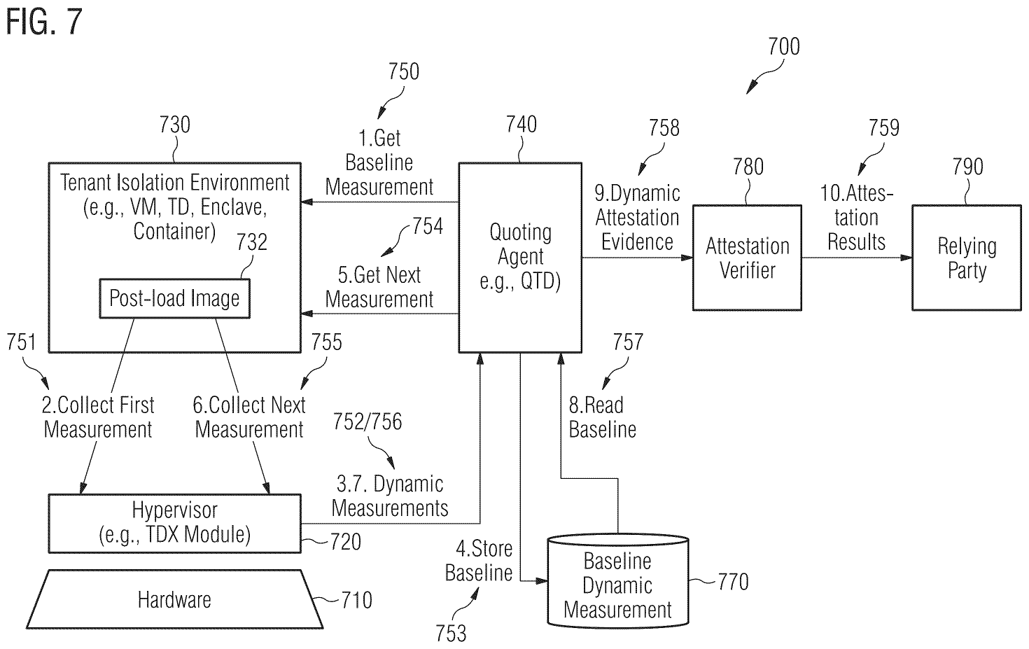

The CCE may comprise one or more hierarchical layered environments (see also FIG. 7). The CCE comprises a workload and one or more layered environments of the CCE. Each of the one or more layered environments may be specifically designed to perform distinct computing functions within the CCE. These layered environments are hierarchically structured such that a lower layered environment may support and attest to the integrity of an environment above it, ensuring a continuous chain of trust throughout the CCE. For example, a lower layered environment may receive a measurement from the environment layered above and sign it with its private key. The one or more layered environments may be categorized into layers based on their functions within the CCE. The layers may be logically and/or hardware-separated based on their specific functions, roles, and responsibilities within the CCE, ensuring a structured and secure computing framework. For example, there may be one or more layers designed to perform foundational security functions, including the Root of Trust (ROT). The RoT may be a hardware-based security component that provides a secure and immutable trust anchor for the layers above. The foundational security provides the essential security mechanisms and trust anchors upon which the entire framework is built. The foundational security framework provides the base upon which the entire CCE's security relies. One example of a foundational security framework is the Device Identifier Composition Engine (DICE) specification. DICE is a hardware-based security mechanism that generates unique cryptographic identities and keys based on the initial measurement of a device's hardware and firmware state during boot. DICE comprises a process that derives cryptographic keys at each stage of the boot process. The keys derived based on DICE may be used to derive various cryptographic keys, including firmware keys and quoting keys, which create a chain of trust through layered identities and attestation. DICE may be defined in the specification “DICE Attestation Architecture” by the Trusted Computing Group, Version 1.1, Revision 0.18, Jan. 6, 2024. Further, a trusted platform manager (also referred to as a Trusted Platform Module, or TPM) may be part of the CCE. The trusted platform manager may record measurements in an integrity register and manage cryptographic keys to sign measurements for internal verification. The trusted platform manager ensures that the system starts from a trusted state, forming the foundational security upon which the CCE operates.

Another environment within the CCE may be the quoting environment (QE), also known as the quoting agent, which is responsible for gathering, formatting, reformatting, and signing measurements and generating attestation evidence (also referred to as quotes) from other layered environments within the CCE. The QE may comprise modules responsible for handling cryptographic operations, such as formatting and signing the integrity measurements collected from higher layers. For instance, the QE may receive measurements from an execution environment and format or sign them with a cryptographic key to produce attestation evidence. This attestation evidence may be consolidated and structured in a way that can be verified by an external attestation verifier. For example, the CCE may comprise an execution environment (such as a tenant environment (TE)) and a service environment (such as a migration environment (ME)). The execution environment may be a secure, isolated execution space dedicated to running a tenant's (user's) applications, data, and workloads.

For example, it may be the same workload that is executed while taking the baseline measurement and the second dynamic measurement. For example, an attacker may not be able to affect a change on the workload between the first and the second measurement events.

The execution environment, such as the tenant environment, is a secure, isolated execution space dedicated to running a tenant's (user's) applications, data, and workload inside the CCE. It is layered on top of the foundational hardware and firmware components of the CCE, which provide the basic secure enclave and isolated execution capabilities. This environment is designed to ensure that the tenant's assets are isolated from other tenants and protected from the underlying system, including the hypervisor and host operating system. The tenant environment may comprise one or more of the following components: A runtime environment, which includes the operating system or some OS layer that provides essential services for application execution; one or more libraries, which are precompiled code modules that offer common functionality needed by the tenant's applications; the tenant's application code, which performs specific tasks or computations; and the data processed by these applications. Further, bring-up code of the tenant environment may be used to initialize and load the one or more components of the tenant environment, taking the measurements of the tenant environment, and/or configuring the secure memory regions and execution contexts needed for their operation. In other words, the bring-up code of the tenant environment establishes and secures the tenant environment, ensuring that it is ready for safe and isolated execution within the CCE.

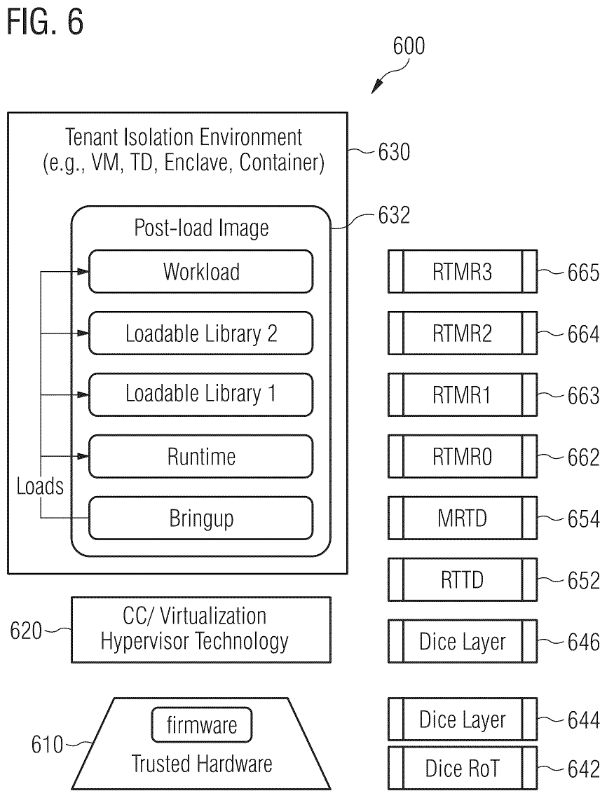

The runtime image may be an in-memory representation of all the components within the execution environment, such as the tenant environment. In some examples, the runtime image comprises at least one of a workload, one or more libraries, which provide supporting functions, a runtime environment, and the bring-up code, as they are actively executed within the CCE. The workload may refer to a specific set of tasks, processes, and/or operations that the system is executing. It may comprise application code and operations performed by that code, as well as any data being processed by the application. The runtime image may be a pre-load image, which may comprise all the components before they have been loaded into memory and initialized for execution. The pre-load image may also be referred to as bring-up (see FIG. 6). It may for example, not be a full workload yet, because the workload may have input data that isn't known at the time the loadable image is created. For example, therefore, still may be a need for runtime measurements, even if only data inputs to the workload are tracked. In some examples, the runtime image may be a post-load image, which may be the complete, in-memory representation of these components after they have been fully loaded and are ready for or currently in execution. The runtime image may comprise executable code and data which may be both loaded into memory as part of the system's operational state. The runtime image, therefore, is an in-memory representation that may include both instructions (code) that the system executes and the data that these instructions act upon. The runtime image encapsulates the state of these components at runtime, reflecting the current configuration, loaded code, and any active data being processed. The runtime image represents the actual executable entity that the CCE protects and isolates, ensuring that the tenant's applications and data are securely managed during execution.

For example, the workload executed at the first point in time and the workload executed at the second point in time may be the same workload, or essentially the same workload, such as the same application. The workload may comprise an application that is executed without interruption. Specific components of the runtime environment, such as the runtime environment itself, libraries, runtime code, or configuration settings, may be dynamically updated through processes like hot patching or software updates. However, the main application or process of the workload continues to run without interruption, even as certain elements of its execution environment are modified to improve functionality, fix bugs, or enhance security. These updates do not require restarting the workload, allowing for continuous operation. The ability to apply such updates during execution ensures that the system can adapt to changes and maintain its integrity and performance without downtime, reflecting a highly flexible and resilient computing environment.

As described above, in some examples, the runtime image may comprise executable code and excludes data. In some examples, the measurement of the runtime image may comprise only executable code and exclude data. For example, integrity of the executable code may be important to ensuring that the system is running trusted and untampered instructions. Measuring data may be problematic due to its dynamic and sensitive nature. In another example, the runtime image may comprise executable code and data. In some examples, the measurement of the runtime image may comprise only executable code and data.

The above described technique allows for the detection of any unauthorized changes or tampering of the CCE and/or the runtime image, ensuring that the runtime image remains secure and unaltered. This can be utilized to monitor and detect unscheduled or malicious changes to CCEs. For example, long-running workloads may be less frequently integrity-checked because resets, which often may trigger re-attestation, occur less often. The above descried technique ensures consistent integrity checking, regardless of whether the workload is short or long-running. This allows periodic system integrity checking policies to be uniformly applied. This consistency enables security risk management teams to better predict and manage security risks in a data center environment, providing robust and reliable protection for sensitive workloads.

In some examples, the generating of the attestation evidence report may comprise at least one of the following: signing the first attestation measurement, signing the second attestation measurement and signing a combination of the first attestation measurement and the second attestation measurement with a cryptographic key.

Signing a measurement may comprise generating a digital signature by encrypting a digest of the measurement, such as a hash, with a private key, thereby ensuring the authenticity and integrity of the measurement. For example, generating a digital signature may comprise creating a cryptographic hash of the measurement and then signing this hash with a private key to produce a digital signature, ensuring the integrity and authenticity of the measurement. A measurement together with its signature may be referred to as signed measurement or attested measurement. The attested measurement may be used in the in the attestation process as described above.

As described above, the CCE may comprise a plurality of layered environments. For example, the CEE may comprise at least one of the following layered environments: foundational environment (such as the Root of Trust (ROT)), a firmware environment, a trusted platform manager environment, a quoting environment, a tenant environment and a migration environment. In some examples, a measurement from a higher layer is signed by a lower layer to maintain a continuous chain of trust. This may be referred to as a trust dependency between the higher layer and the lower layer.

For example, the singing of the runtime image (which may be similar to a measurement of the tenant environment) may be done by a quoting environment. That is the signed measurement of the runtime image may have a trust dependency on the quoting environment. The quoting environment may again have a trust dependency on a lower layered environment which may establish a continuous chain of trust down to the hardware RoT. For example, a higher layer is signed with the private key of a lower layer, and the public key of the private-public key pair of the higher layer may also be signed with the private key of the lower layer. This ensures that the public key, when used to verify the measurement, is authenticated by the lower layer's signature. A private-public key pair, also known as asymmetric cryptography or public-key cryptography, is a cryptographic tool used for secure communication and authentication. The private key is kept secret and is used to sign data, creating a digital signature that verifies the data's integrity and origin. The corresponding public key is shared openly and is used to verify the digital signature created by the private key, ensuring that the data has not been tampered with and confirming the identity of the sender. This pair enables secure data exchange and authentication without needing to share the private key, thus maintaining security. The integrity of upper layered environments may depend on the integrity of lower layered environments, that is there may be a trust dependency between of the layers of CCE.

In some examples, least one of the following trust dependencies applies: a signed measurement of the runtime image (for example of the tenant environment) has a trusted dependency on the quoting environment, a signed measurement of the quoting environment has a trust dependency on the trusted platform environment, a signed measurement of the trusted platform has a trust dependency on the package firmware environment, and a signed measurement of the firmware environment has a trust dependency on the root of trust of a processor executing the CCE. For example, the RoT, as the lowest layer and part of the processing circuitry 130, may receive a measurement taken from the firmware. The RoT signs the measurement of the firmware with its private key and also signs the public key of the firmware. Next, the firmware environment receives a measurement taken of the trusted platform manager environment, signs it with its private key, and also signs the public key of the trusted platform manager. It may also include the previously signed measurement from the RoT. For example, this process may continue for further subsequent layers, for example up to the QE. The QE then receives measurements taken from higher layers, such as the runtime image (for example the tenant environment), and signs them with its private key. The corresponding public key is verified by the lower layers.

In some examples, the second point in time is later than the first point in time. For example, the second measurement is a subsequent measurement to the first attestation measurement, which is stored as a baseline attestation measurement. In some examples, generating the second attestation measurement of the runtime image at the second point in time is triggered by an event. For example, the event may be any significant action or process that requires verification of the integrity of the runtime image to ensure that the CCE remains secure and trusted. For instance, the event may be an application executed in the runtime image that requests a dynamic measurement to ensure it is executing within a secure and trusted CCE, particularly when handling confidential data or performing critical tasks. For example, this may occur in the context of a financial transaction, where the integrity of the CCE and the runtime image is crucial, and the transaction process triggers a dynamic measurement to confirm that the system has not been tampered with since the last attestation. The second attestation measurement may then be compared against the stored baseline attestation measurement, allowing for real-time verification of the system's integrity and providing assurance to the verifier that the CCE remains secure and trustworthy throughout its operation. Additionally, the event may be triggered by a quoting request from the quoting environment, where the CCE is asked to generate and provide an up-to-date attestation measurement of its integrity. In some examples, the processing circuitry 130 is further configured to generate a plurality of attestation measurements of the runtime image executed in the CCE at a plurality of points in time. Further, the processing circuitry 130 may be configured generate a plurality of attestation evidence reports. Each of the plurality of attestation evidence reports may be based on the baseline attestation measurement and the respective attestation measurement. For example, the plurality of points in time are scheduled points in time, for example, in regular, periodic intervals. The corresponding plurality of attestation measurements ensure continuous monitoring of the runtime image and CCE's integrity, providing a steady stream of attestation measurements. For each scheduled measurement, the processing circuitry 130 is configured to generate a corresponding attestation evidence report. This approach allows for ongoing verification of the runtime image's integrity, ensuring that any unauthorized changes or tampering are detected promptly, even in the absence of specific triggering events.

### Updating the Baseline Attestation Measurement

In some examples, the processing circuitry 130 may be configured to remove the stored baseline attestation measurement from the storage circuitry if an alteration is applied to the runtime image and a new baseline attestation measurement is generated. Further, processing circuitry 130 may be configured to generate a third attestation measurement of the runtime image executed in the CCE after altering the runtime image. Further, processing circuitry 130 may be configured to store the third attestation measurement as baseline attestation measurement in the storage circuitry. As described above the alteration of the runtime image or one of its components and/or on one or more components of the CCE may comprise a patch, a hot patch, a software update, or other authorized alterations. These alterations may lead to changes in the runtime image. After such an alteration, the stored baseline attestation measurement may no longer accurately reflect the new, altered state of the runtime image and/or the CCE. If in such a case, a dynamic measurement is taken and transmitted to the verifier along with the stored baseline attestation measurement, the verifier may assess the dynamic measurement as not matching the baseline attestation measurement, potentially indicating tampering. Therefore, in this case the new baseline attestation measurement (the third measurement) may be generated and may replace the old baseline attestation measurement in the storage circuitry.

In some examples, the old baseline attestation measurement may be updated as the current baseline attestation measurement but may still be stored and not removed. In some examples, one or more old baseline attestation measurements may be included into the attestation evidence report. The old baseline attestation measurements have been in effect previously. It may be used to verify how an alteration of the runtime image was applied.

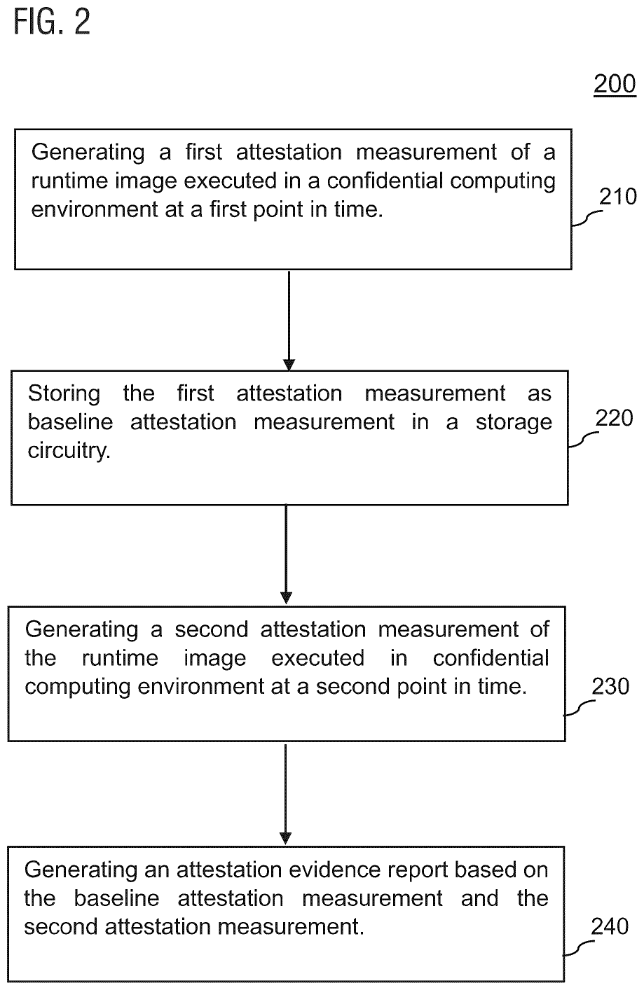

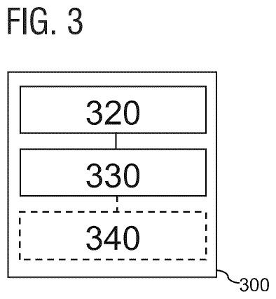

Further details and aspects are mentioned in connection with the examples described below. The example shown in FIG. 1 may include one or more optional additional features corresponding to one or more aspects mentioned in connection with the proposed concept or one or more examples described or below (e.g., FIGS. 2-7).

FIG. 2 illustrates a flowchart of an example of a method 200. The method 200 may, for instance, be performed by an apparatus as described herein, such as apparatus 100, apparatus 300 and/or system 500. The method 200 comprises 210 generating a first attestation measurement of a runtime image executed in a confidential computing environment at a first point in time. The method 200 further comprises 220 storing the first attestation measurement as baseline attestation measurement in a storage circuitry. The method 200 further comprises 230 generating a second attestation measurement of the runtime image executed in confidential computing environment at a second point in time. The method 200 further comprises 240 generating an attestation evidence report based on the baseline attestation measurement and the second attestation measurement.

More details and aspects of the method 200 are explained in connection with the proposed technique or one or more examples described above (e.g., with reference to FIGS. 1 and 3 and 5), or below. The method 200 may comprise one or more additional optional features corresponding to one or more aspects of the proposed technique, or one or more examples described above (e.g., FIG. 1) or below (e.g., FIGS. 3-7).

### Apparatus for Verifying an Attestation Measurement

FIG. 3 illustrates a block diagram of an example of an apparatus for verifying an attestation measurement 300 or device for verifying an attestation measurement 300. The apparatus 300 comprises circuitry that is configured to provide the functionality of the apparatus 300. For example, the apparatus 300 of FIG. 3 comprises interface circuitry 320, processing circuitry 330 and (optional) storage circuitry 340. For example, the processing circuitry 330 may be coupled with the interface circuitry 320 and optionally with the storage circuitry 340.

For example, the processing circuitry 330 may be configured to provide the functionality of the apparatus 300, in conjunction with the interface circuitry 320. For example, the interface circuitry 320 is configured to exchange information, e.g., with other components inside or outside the apparatus 300 and the storage circuitry 340. Likewise, the device 300 may comprise means that is/are configured to provide the functionality of the device 300.

The components of the device 300 are defined as component means, which may correspond to, or implemented by, the respective structural components of the apparatus 300. For example, the device 300 of FIG. 3 comprises means for processing 330, which may correspond to or be implemented by the processing circuitry 330, means for communicating 320, which may correspond to or be implemented by the interface circuitry 320, and (optional) means for storing information 340, which may correspond to or be implemented by the storage circuitry 340. In the following, the functionality of the device 300 is illustrated with respect to the apparatus 300. Features described in connection with the apparatus 300 may thus likewise be applied to the corresponding device 300.

In general, the functionality of the processing circuitry 330 or means for processing 330 may be implemented by the processing circuitry 330 or means for processing 330 executing machine-readable instructions. Accordingly, any feature ascribed to the processing circuitry 330 or means for processing 330 may be defined by one or more instructions of a plurality of machine-readable instructions. The apparatus 300 or device 300 may comprise the machine-readable instructions, e.g., within the storage circuitry 340 or means for storing information 340.

The interface circuitry 320 or means for communicating 320 may correspond to one or more inputs and/or outputs for receiving and/or transmitting information, which may be in digital (bit) values according to a specified code, within a module, between modules or between modules of different entities. For example, the interface circuitry 320 or means for communicating 320 may comprise circuitry configured to receive and/or transmit information.

For example, the processing circuitry 330 or means for processing 130 may be implemented using one or more processing units, one or more processing devices, any means for processing, such as a processor, a computer or a programmable hardware component being operable with accordingly adapted software. In other words, the described function of the processing circuitry 330 or means for processing 330 may as well be implemented in software, which is then executed on one or more programmable hardware components. Such hardware components may comprise a general-purpose processor, a Digital Signal Processor (DSP), a micro-controller, etc.

For example, the storage circuitry 340 or means for storing information 340 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

The processing circuitry 330 is configured to receive an attestation evidence report comprising a baseline attestation measurement and a second attestation measurement. The baseline attestation measurement is based on a runtime image executed in a CCE at a first point in time. The second attestation measurement is based on the runtime image executed in the CCE at a second point in time. Further, the processing circuitry 330 is configured to compare the baseline attestation measurement and the second attestation measurement. Further, the processing circuitry 330 is configured to generate a positive attestation result if the baseline attestation measurement and the second attestation measurement match. In some examples, second point in time is later than the first point in time.

In some examples, the processing circuitry 330 is further configured to verify at least one of the first attestation measurement and the second attestation measurement. The apparatus 300 may be configured as verifier as described above with regards to FIGS. 1 and 2.

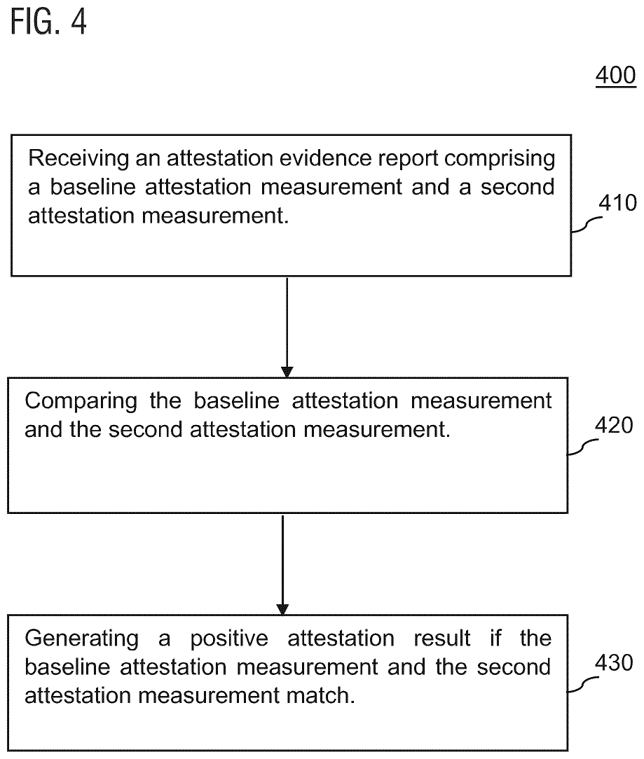

Further details and aspects are mentioned in connection with the examples described above or below. The example shown in FIG. 3 may include one or more optional additional features corresponding to one or more aspects mentioned in connection with the proposed concept or one or more examples described above (e.g., FIGS. 1-2) or below (e.g., FIGS. 4-7).

FIG. 4 illustrates a flowchart of an example of a method 400. The method 400 may, for instance, be performed by an apparatus as described herein, such as apparatus 300. The method 400 comprises receiving an attestation evidence report comprising a baseline attestation measurement and a second attestation measurement. The baseline attestation measurement is based on a runtime image executed in a confidential computing environment at a first point in time. The second attestation measurement is based on the runtime image executed in the confidential computing environment at a second point in time. The method 400 further comprises 420 comparing the baseline attestation measurement and the second attestation measurement. The method 400 further comprises 430 generating a positive attestation result if the baseline attestation measurement and the second attestation measurement match.

In some examples, the method 400 may further comprise comparing the baseline attestation measurement and the second attestation measurement. Further, the method 400 may comprise generating a positive attestation result if the baseline attestation measurement and the second attestation measurement match.

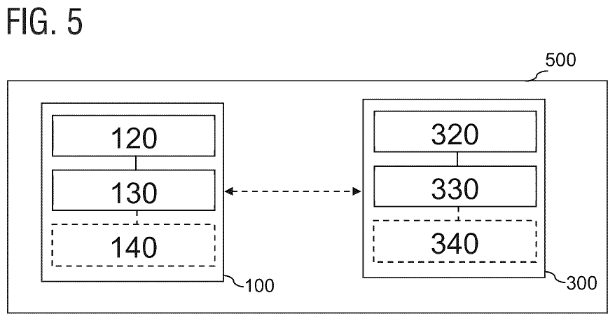

More details and aspects of the method 400 are explained in connection with the proposed technique or one or more examples described above (e.g., with reference to FIG. 3), or below. The method 400 may comprise one or more additional optional features corresponding to one or more aspects of the proposed technique, or one or more examples described above (e.g., FIGS. 1 to 3) or below (e.g., FIGS. 5-7).

FIG. 5 illustrates a system 500. The system 500 comprises the apparatus for generating an attestation measurement 100, as for examples described with regards to FIG. 1. The system 500 further comprise the apparatus the apparatus for verifying the attestation measurement 300 as described for example with regards to FIG. 3.

For example, the apparatus for generating an attestation measurement 100 and the apparatus for verifying the attestation measurement 300 may communicate via the interface circuitry 120 of the apparatus 100 and the interface circuitry 320 of the apparatus 300.

### Further Examples

FIG. 6 illustrates an example of an architecture of a CCE 600. The CCE 600 (for example Intel® TDX) comprises a foundational security framework 610 which comprises a root of trust (ROT) and firmware. For example, the security framework 610 may also comprise a trusted platform manager. Further, the CCE 600 comprise a trusted resource manager 620, for example a hypervisor. The resource manager may manage the secure and confidential I/O operations between the CCE and the computer system that is hosting the CCE 600. For example, the trusted resource manager 620 may manage the I/O memory operations between the host memory and the CCE. For example, the resource manager may be implemented as a hypervisor, such as e.g., Intel® TDX Module, Intel® VMM and/or Intel® SGX. The CCE 600 further comprises the execution environment 630 (also referred to as tenant execution environment). The tenant may comprise the post-load image 632 (in some examples, the post-load image and the tenant environment may be considered the same). The post-load image 632 comprises a bring-up code, a runtime environment, a loadable library 1 and a loadable library 2 and the workload. The bring-up code may comprise a loader that loads, measures, and installs images of the runtime environment, the libraries, and the workload (also referred to as application code). The bring-up code applies static and/or dynamic linking needed to enable the completed runtime image 632 to execute. The completed executable runtime 632 is referred to post-load image. The post-load image 632 may contain multiple applications (though FIG. 6 only shows one) and may be implemented with virtualization technology that overlays a ringed architecture, such as x86 rings where application code may execute at ring 3 and system code may execute at ring 0. The CCE 600 may take a measurement of its different components. These measurements may be stored in different storage locations which are associated to and/or part of the CCCE 600. The CCE 600 comprises

A static attestation measurement of a component of the CCE 600, for example a load-time measurement of the bring-up code block that is initialized into the CCE at start time, may be stored in into a static integrity register such as TDX MRTD 654. For example, the trusted resource manager 620 (e.g., TDX Module), that initializes the CCE 600, writes into the static integrity register 654. Further, the load-time measurements of other components of the tenant environment 630, for example, the libraries, the runtime environment or the workload may be recorded, for example by the trusted resource manager 620, into any of the runtime integrity registers for static measurements (e.g., RMTR) 662, 663, 664, 665.

Further, the attestation capabilities of the CCE 600 comprise dynamic attestation as described above. In this regard, the resource manager 620 implements the measurement collection function that reads the CEE memory regions to collect a (dynamic) measurement of the post-load runtime image 632. This post-load runtime image 632 may not be a contiguously laid out set of pages in memory of the CCE 600 but may follow address layout randomization schemes (such Address layout randomization, see also as space https://en.wikipedia.org/w/index.php?title=Address_space_layout_randomization&oldid=123 1655363) and page remapping schemes to properly walk the in-memory representation. For example, a digest of the post-load runtime image 632 is recorded into runtime integrity register for dynamic measurements 652, for example a runtime trusted domain register (RTTD). The measurement stored in the runtime integrity register for dynamic measurements 652 may be included in attestation evidence reports (or into other signed quote structures) as described above and below that construct attestation evidence suitable for input to an attestation verifier such as Intel® Trust Authority.

Further details and aspects are mentioned in connection with the examples described above or below. The example shown in FIG. 6 may include one or more optional additional features corresponding to one or more aspects mentioned in connection with the proposed concept or one or more examples described above (e.g., FIGS. 1-5) or below (e.g., FIG. 7).

FIG. 7 illustrates an example of a flow chart of a dynamic measurement process of a CCE. The CCE comprises the foundational security framework 710 and a trusted resource manager 720 (for example a hypervisor such as the Intel® TDX Module). The CCE further comprises an execution environment 730 (such as a tenant environment like a virtual machine, a trusted domain, an enclave or a container). The execution environment 730 is running a runtime image 732. Further, the CCE comprises a quoting environment (also referred to as quoting agent) 740 such as Intel® TDX quoting TD (QTD) where a request to obtain a quote is processed.

In step 750 the quoting environment 740 requests a (dynamic) baseline attestation measurement of the runtime image 732, running in the execution environment 730 of the CCE. This request causes the CEE in step 751 to invoke the trusted resource manager 720 (e.g., TDX Module) to read memory pages within the CCE containing code. The dynamic attestation measurement is taken by the trusted resource manager 720. In step 752 the first dynamic attestation measurement is delivered to quoting environment 740 where it is validated and for example signed. In step 753 the this first dynamic attestation measurement is recorded as baseline attestation measurement into in a storage circuitry 770, for example a runtime integrity measurement registers such as a RTTD register. At some point in the future, in step 754 a request to obtain a dynamic attestation measurement is for received by the quoting environment 740 which results in a request to the CCE to obtain the second dynamic attestation measurement. In step 755 the trusted resource manager 720 (such as a hypervisor or TDX Module) performs the memory read operation as performed in step 751, however since the baseline attestation measurement already is in place and no alteration to the runtime image 732 has taken place, this second attestation measurement is not used as the baseline attestation measurement. In step 756 the second dynamic attestation measurement is recorded into the runtime integrity measurement register 770 such as a RTTD register and delivered to the quoting environment 740. In step 757 the quoting environment 740 reads and validates the second attestation measurement from the integrity register 770. In step 758 the quoting environment 740 generates a dynamic attestation evidence report (also referred to as a dynamic quote). The attestation evidence report contains both the baseline attestation measurement and second dynamic attestation measurement. The dynamic attestation evidence report may further be singed the delivered and transmitted to the to an attestation verifier 780. The verifier 780 compares the baseline attestation measurement with the second dynamic attestation measurement. In step 759 an attestation result is generated. If baseline attestation measurement and second dynamic attestation measurement match, then a positive attestation result is generated indicating the positive comparison result. The attestation result may be delivered to a relying party 790, which wants to know of the CCE and/or the runtime image, for example the application, which is part of the runtime image 732, is un-tampered and secure.

The dynamic attestation evidence report may further contain the names of all the modules that were loaded into the CEE that were the ingredients to the post-load image 732. The verifier 780 may uses these names to further verify the ingredients as part of a more thorough appraisal that re-checks the static attestation evidence. Rechecking static attestation evidence can reveal an update to the RIMs that may now include vulnerability reports that were issued subsequently. The dynamic attestation evidence report may integrate both static and dynamic attestation measurements with CCE attestation infrastructure to more effectively assess the integrity of a running CCE. This enables periodic integrity checks of long-running CCEs that may not otherwise be able to report integrity status.

Further details and aspects are mentioned in connection with the examples described above. The example shown in FIG. 7 may include one or more optional additional features corresponding to one or more aspects mentioned in connection with the proposed concept or one or more examples described above (e.g., FIGS. 1-6).

In the following, some examples of the proposed concept are presented:

An example (e.g., example 1) relates to an apparatus for generating an attestation measurement comprising interface circuitry, machine-readable instructions and processing circuitry to execute the machine-readable instructions to generate a first attestation measurement of a runtime image executed in a confidential computing environment at a first point in time, store the first attestation measurement as baseline attestation measurement in a storage circuitry, generate a second attestation measurement of the runtime image executed in confidential computing environment at a second point in time, generate an attestation evidence report based on the baseline attestation measurement and the second attestation measurement.

Another example (e.g., example 2) relates to a previous example (e.g., example 1) or to any other example, further comprising that the processing circuitry is further to execute the machine-readable instructions to compare the baseline attestation measurement and the second attestation measurement and generate a positive attestation result if the baseline attestation measurement and the second attestation measurement match.

Another example (e.g., example 3) relates to a previous example (e.g., example 2) or to any other example, further comprising that the second point in time is later than the first point in time

Another example (e.g., example 4) relates to a previous example (e.g., example 3) or to any other example, further comprising that the baseline attestation measurement is stored the storage circuitry for subsequent audit and compliance inspections.

Another example (e.g., example 5) relates to a previous example (e.g., one of the examples 1 to 4) or to any other example, further comprising that the processing circuitry is further to execute the machine-readable instructions to remove the stored baseline attestation measurement from the storage circuitry if an alteration is applied to the runtime image, and generate a third attestation measurement of the runtime image executed in the confidential computing environment after altering the runtime image, store the third attestation measurement as baseline attestation measurement in the storage circuitry.

Another example (e.g., example 6) relates to a previous example (e.g., one of the examples 1 to 5) or to any other example, further comprising that the processing circuitry is further to execute the machine-readable instructions to generate a plurality of attestation measurements of the runtime image executed in the confidential computing environment at a plurality of points in time, generate a plurality of attestation evidence reports, each of the plurality of attestation evidence reports being based on the baseline attestation measurement and the respective attestation measurement. 7 The apparatus of any one of examples 1 to 6, wherein generating the second attestation measurement of the runtime image at the second point in time is triggered by an event.

Another example (e.g., example 8) relates to a previous example (e.g., one of the examples 1 to 7) or to any other example, further comprising that generating the attestation evidence report comprises at least one of the following signing the first attestation measurement, signing the second attestation measurement and signing a combination of the first attestation measurement and the second attestation measurement with a cryptographic key.

Another example (e.g., example 9) relates to a previous example (e.g., one of the examples 1 to 8) or to any other example, further comprising that the runtime image comprises at least one of a workload, one or more libraries, a runtime environment and a bring-up code.

Another example (e.g., example 10) relates to a previous example (e.g., one of the examples 1 to 9) or to any other example, further comprising that the runtime image comprises executable code and excludes data.

Another example (e.g., example 11) relates to a previous example (e.g., one of the examples 1 to 10) or to any other example, further comprising that the processing circuitry is further to execute the machine-readable instructions to transmit the attestation evidence report to a verifier.

Another example (e.g., example 12) relates to a previous example (e.g., one of the examples 1 to 10) or to any other example, further comprising that the processing circuitry is further to execute the machine-readable instructions to transmit the attestation evidence report to a verifier which is configured to compare the baseline attestation measurement and the second attestation measurement.

An example (e.g., example 13) relates to an apparatus for verifying an attestation measurement comprising interface circuitry, machine-readable instructions and processing circuitry to execute the machine-readable instructions to receive an attestation evidence report comprising a baseline attestation measurement and a second attestation measurement, wherein the baseline attestation measurement is based on a runtime image executed in a confidential computing environment at a first point in time, wherein the second attestation measurement is based on the runtime image executed in the confidential computing environment at a second point in time, compare the baseline attestation measurement and the second attestation measurement, and generate a positive attestation result if the baseline attestation measurement and the second attestation measurement match.

Another example (e.g., example 14) relates to a previous example (e.g., example 13) or to any other example, further comprising that the second point in time is later than the first point in time.

Another example (e.g., example 15) relates to a previous example (e.g., one of the examples 13 to 14) or to any other example, further comprising that the processing circuitry is further to execute the machine-readable instructions to verify at least one of the first attestation measurement and the second attestation measurement.

An example (e.g., example 16) relates to a system comprising the apparatus for generating an attestation measurement according to any one of examples 1 to 12, the apparatus for verifying an attestation measurement according to any one of examples 13 to 15. 17. A method comprising generating a first attestation measurement of a runtime image executed in a confidential computing environment at a first point in time, storing the first attestation measurement as baseline attestation measurement in a storage circuitry, generating a second attestation measurement of the runtime image executed in confidential computing environment at a second point in time, generating an attestation evidence report based on the baseline attestation measurement and the second attestation measurement. 18. The method according to example 17 further comprising comparing the baseline attestation measurement and the second attestation measurement, and generating a positive attestation result if the baseline attestation measurement and the second attestation measurement match

Another example (e.g., example 19) relates to a previous example (e.g., example 18) or to any other example, further comprising that the second point in time is later than the first point in time

Another example (e.g., example 20) relates to a previous example (e.g., example 19) or to any other example, further comprising that the baseline attestation measurement is stored the storage circuitry for subsequent audit and compliance inspections.

Another example (e.g., example 21) relates to removing the stored baseline attestation measurement from the storage circuitry if an alteration is applied to the runtime image, and generating a third attestation measurement of the runtime image executed in the confidential computing environment after altering the runtime image, storing the third attestation measurement as baseline attestation measurement in the storage circuitry.

Another example (e.g., example 22) relates to generating a plurality of attestation measurements of the runtime image executed in the confidential computing environment at a plurality of points in time, generating a plurality of attestation evidence reports, each of the plurality of attestation evidence reports being based on the baseline attestation measurement and the respective attestation measurement.

Another example (e.g., example 23) relates to a previous example (e.g., one of the examples 17 to 22) or to any other example, further comprising that generating the second attestation measurement of the runtime image at the second point in time is triggered by an event.

Another example (e.g., example 24) relates to a previous example (e.g., one of the examples 17 to 23) or to any other example, further comprising that generating the attestation evidence report comprises at least one of the following signing the first attestation measurement, signing the second attestation measurement and signing a combination of the first attestation measurement and the second attestation measurement with a cryptographic key.

Another example (e.g., example 25) relates to a previous example (e.g., one of the examples 17 to 24) or to any other example, further comprising that the runtime image comprises at least one of a workload, one or more libraries, a runtime environment and a bring-up code.

Another example (e.g., example 26) relates to a previous example (e.g., one of the examples 17 to 25) or to any other example, further comprising that the runtime image comprises executable code and excludes data.

Another example (e.g., example 27) relates to transmitting the attestation evidence report to a verifier.

Another example (e.g., example 28) relates to transmitting the attestation evidence report to a verifier which is configured to compare the baseline attestation measurement and the second attestation measurement.

An example (e.g., example 29) relates to a method for verifying an attestation measurement comprising receiving an attestation evidence report comprising a baseline attestation measurement and a second attestation measurement, wherein the baseline attestation measurement is based on a runtime image executed in a confidential computing environment at a first point in time, wherein the second attestation measurement is based on the runtime image executed in the confidential computing environment at a second point in time, comparing the baseline attestation measurement and the second attestation measurement, and generating a positive attestation result if the baseline attestation measurement and the second attestation measurement match.

Another example (e.g., example 30) relates to a previous example (e.g., example 29) or to any other example, further comprising that the second point in time is later than the first point in time.

Another example (e.g., example 32) relates to verifying at least one of the first attestation measurement and the second attestation measurement.

In the following, some examples of the proposed concept are presented:

An example (e.g., example 33) relates to an apparatus comprising processor circuitry configured to generate a first attestation measurement of a runtime image executed in a confidential computing environment at a first point in time, store the first attestation measurement as baseline attestation measurement in a storage circuitry, generate a second attestation measurement of the runtime image executed in confidential computing environment at a second point in time, generate an attestation evidence report based on the baseline attestation measurement and the second attestation measurement.

An example (e.g., example 34) relates to an apparatus comprising processor circuitry configured to receive an attestation evidence report comprising a baseline attestation measurement and a second attestation measurement, wherein the baseline attestation measurement is based on a runtime image executed in a confidential computing environment at a first point in time, wherein the second attestation measurement is based on the runtime image executed in the confidential computing environment at a second point in time, compare the baseline attestation measurement and the second attestation measurement, and generate a positive attestation result if the baseline attestation measurement and the second attestation measurement match.

An example (e.g., example 35) relates to a device comprising means for processing for generating a first attestation measurement of a runtime image executed in a confidential computing environment at a first point in time, storing the first attestation measurement as baseline attestation measurement in a storage circuitry, generating a second attestation measurement of the runtime image executed in confidential computing environment at a second point in time, generating an attestation evidence report based on the baseline attestation measurement and the second attestation measurement.

An example (e.g., example 36) relates to a device comprising means for processing for receiving an attestation evidence report comprising a baseline attestation measurement and a second attestation measurement, wherein the baseline attestation measurement is based on a runtime image executed in a confidential computing environment at a first point in time, wherein the second attestation measurement is based on the runtime image executed in the confidential computing environment at a second point in time, comparing the baseline attestation measurement and the second attestation measurement, and generating a positive attestation result if the baseline attestation measurement and the second attestation measurement match.

Another example (e.g., example 37) relates to a non-transitory machine-readable storage medium including program code, when executed, to cause a machine to perform any of the methods of examples 17 to 32.

Another example (e.g., example 38) relates to a computer program having a program code for performing any of the methods of examples 17 to 32 when the computer program is executed on a computer, a processor, or a programmable hardware component.

Another example (e.g., example 39) relates machine-readable storage including machine readable instructions, when executed, to implement a method or realize an apparatus as claimed in any pending examples.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F) PLAs), (field) programmable gate arrays ((F) PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus for generating an attestation measurement comprising interface circuitry, machine-readable instructions and processing circuitry to execute the machine-readable instructions to:
generate a first attestation measurement of a runtime image executed in a confidential computing environment at a first point in time;
store the first attestation measurement as baseline attestation measurement in a storage circuitry;
generate a second attestation measurement of the runtime image executed in confidential computing environment at a second point in time;
generate an attestation evidence report based on the baseline attestation measurement and the second attestation measurement.

2. The apparatus of claim 1, wherein the processing circuitry is further to execute the machine-readable instructions to compare the baseline attestation measurement and the second attestation measurement; and
generate a positive attestation result if the baseline attestation measurement and the second attestation measurement match.

3. The apparatus of claim 1, wherein the second point in time is later than the first point in time.

4. The apparatus of claim 1, wherein the baseline attestation measurement is stored the storage circuitry for subsequent audit and compliance inspections.

5. The apparatus of claim 1, wherein the processing circuitry is further to execute the machine-readable instructions to remove the stored baseline attestation measurement from the storage circuitry if an alteration is applied to the runtime image; and
generate a third attestation measurement of the runtime image executed in the confidential computing environment after altering the runtime image;
store the third attestation measurement as baseline attestation measurement in the storage circuitry.

6. The apparatus of claim 1, wherein the processing circuitry is further to execute the machine-readable instructions to generate a plurality of attestation measurements of the runtime image executed in the confidential computing environment at a plurality of points in time;
generate a plurality of attestation evidence reports, each of the plurality of attestation evidence reports being based on the baseline attestation measurement and the respective attestation measurement.

7. The apparatus of claim 1, wherein generating the second attestation measurement of the runtime image at the second point in time is triggered by an event.

8. The apparatus of claim 1, wherein generating the attestation evidence report comprises at least one of the following: signing the first attestation measurement, signing the second attestation measurement and signing a combination of the first attestation measurement and the second attestation measurement with a cryptographic key.

9. The apparatus of claim 1, wherein the runtime image comprises at least one of a workload, one or more libraries, a runtime environment and a bring-up code.

10. The apparatus of claim 1, wherein the runtime image comprises executable code and excludes data.

11. The apparatus of claim 1, wherein the processing circuitry is further to execute the machine-readable instructions to transmit the attestation evidence report to a verifier.

12. The apparatus of claim 1, wherein the processing circuitry is further to execute the machine-readable instructions to transmit the attestation evidence report to a verifier which is configured to compare the baseline attestation measurement and the second attestation measurement.

13. An apparatus for verifying an attestation measurement comprising interface circuitry, machine-readable instructions and processing circuitry to execute the machine-readable instructions to:
receive an attestation evidence report comprising a baseline attestation measurement and a second attestation measurement,
wherein the baseline attestation measurement is based on a runtime image executed in a confidential computing environment at a first point in time,
wherein the second attestation measurement is based on the runtime image executed in the confidential computing environment at a second point in time;
compare the baseline attestation measurement and the second attestation measurement; and
generate a positive attestation result if the baseline attestation measurement and the second attestation measurement match.

14. The apparatus of claim 13, wherein the second point in time is later than the first point in time.

15. The apparatus of claim 13, wherein the processing circuitry is further to execute the machine-readable instructions to verify at least one of the first attestation measurement and the second attestation measurement.

16. A method comprising:
generating a first attestation measurement of a runtime image executed in a confidential computing environment at a first point in time;
storing the first attestation measurement as baseline attestation measurement in a storage circuitry;
generating a second attestation measurement of the runtime image executed in confidential computing environment at a second point in time;
generating an attestation evidence report based on the baseline attestation measurement and the second attestation measurement.

17. The method of claim 16 further comprising:
comparing the baseline attestation measurement and the second attestation measurement; and
generating a positive attestation result if the baseline attestation measurement and the second attestation measurement match.

18. The method of claim 16, wherein the second point in time is later than the first point in time.

19. The method of claim 16, wherein the baseline attestation measurement is stored the storage circuitry for subsequent audit and compliance inspections.

20. The method of claim 16 further comprising:
removing the stored baseline attestation measurement from the storage circuitry if an alteration is applied to the runtime image; and
generating a third attestation measurement of the runtime image executed in the confidential computing environment after altering the runtime image;
storing the third attestation measurement as baseline attestation measurement in the storage circuitry.
